(19) United States
(12) Patent Application Publication
(10) Pub. No.: US 2012/0079534 A1
(43) Pub. Date: Mar. 29, 2012

(54) SET-TOP BOX AND METHOD FOR SEARCHING TEXT IN VIDEO PROGRAMS

(75) Inventor: CHIEN-TSANG HUANG, Tu-Cheng (TW)

(73) Assignee: HON HAI PRECISION INDUSTRY CO., LTD., Tu-Cheng (TW)

(21) Appl. No.: 12/915,030

(22) Filed: Oct. 29, 2010

(30) Foreign Application Priority Data
Sep. 23, 2010 (TW) 99132200

(51) Int. Cl. H04N 5/445; G06K 9/00; H04N 7/173

(52) U.S. Cl. 725/37; 725/110; 382/100

(57) ABSTRACT

A set-top box captures a video frame of a video program of a television, and analyzes the video frame to retrieve text in the video frame. The set-top box further searches information regarding the text on the Internet, and transmits the information regarding the text to the television for display.

### BACKGROUND

1. Technical Field

The present disclosure relates to web communications, and more particularly to a set-top box and a method for searching text in video programs.

2. Description of Related Art

Set-top boxes are becoming more and more popular in our daily lives to provide digital television services. The provided television services by the set-top boxes generally comprise pictures as well as text accompanying with the pictures. If a user wants to know relevant knowledge about the text, the set-top box has no the function to search on the Internet information related to the interested text.

Therefore, what is needed is a set-top box to amend the aforementioned problem.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is an application environment of one embodiment of a set-top box in accordance with the present disclosure;

FIG. 2 is a schematic diagram of functional modules of one embodiment of a set-top box in accordance with the present disclosure;

FIG. 3 is a flowchart of one embodiment of a method for searching text in accordance with the present disclosure; and

FIG. 4 is a flowchart of another embodiment of a method for searching text in accordance with the present disclosure.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

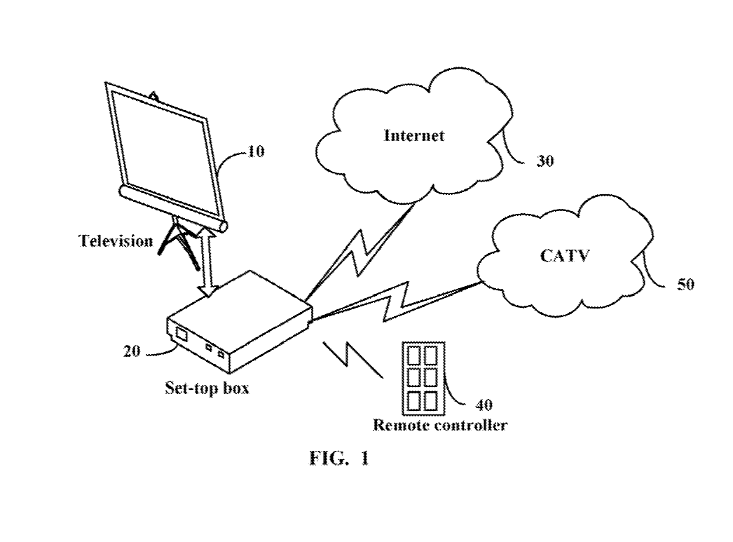

FIG. 1 is an application environment of one embodiment of a set-top box 20 in accordance with the present disclosure. In one embodiment, the set-top box 20 is connected to a television (TV) 10, the Internet 30, and a cable television (CATV) 50. The set-top box 20 is operable to process digital television programs from the Internet 30 and/or the CATV 50, convert the digital television programs into analog television programs, and transmit the analog television programs to the television 10. In one embodiment, the set-top box 20 can capture a video frame from a television program played by the TV 10, and search information regarding the text of the video frame on the Internet 30. For example, a user can send an image capturing instruction to the set-top box 20 by a remote controller 40 if the user is interested in the text in the television program. In such a case, the set-top box 20 can capture a video frame from the TV 10 when the image capturing instruction is received. Then, the set-top box 20 analyzes the video frame to retrieve text in the video frame, and searches information about the text on the Internet 30.

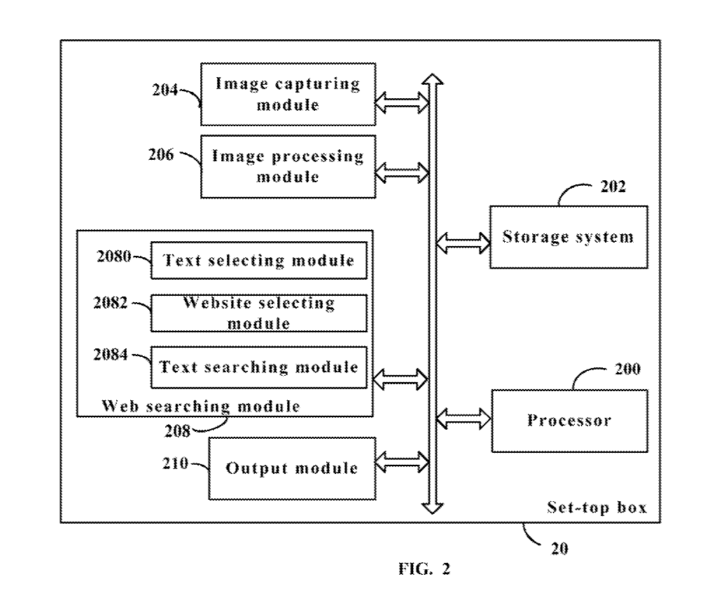

FIG. 2 is a schematic diagram of functional modules of one embodiment of the set-top box 20 in accordance with the present disclosure.

The set-top box 20 includes a storage system 202, an image capturing module 204, an image processing module 206, a web searching module 208, and at least one processor 200. The modules 204-208 may comprise computerized code in the form of one or more programs that are stored in the storage system 202 (or memory). The computerized code includes instructions that are executed by the at least one processor 200 to provide functions for modules 204-208.

The image capturing module 204 is operable to capture a video frame of a video program of the television 10 in response to a first instruction input by a user. In one embodiment, the user sends an image capturing instruction to the set-top box 20 by a remote controller 40 if the user is interested in the text in the television program. The text can include letters and numbers and can be part of the title of the television program, subtitles, or other text in the television program. The image capturing module 204 captures a current video frame of the television program of the TV 10 when receiving the image capturing instruction. For example, if the TV 10 is playing a television program that is displaying the title of “CLASH OF THE TITANS,” the user can send an image capturing instruction to the set-top box 20 by the remote controller 40 if the user is interested in “CLASH OF THE TITANS”. Then, the image capturing module 204 captures a video frame from the TV 10 containing the text “CLASH OF THE TITANS”.

The image processing module 206 is operable to retrieve one or more text in the video frame, such as “CLASH OF THE TITANS” from the video frame. In one embodiment, the image processing module 206 can determine text features from the video frame to retrieve the text of the video frame. In detail, the image processing module 206 converts the video frame into a gray scale image, then determines text features in the gray scale image. If the gray scale image contains text features, the gray scale image is cut into a plurality of areas according to the text features. The image processing module 206 analyzes the text of every area with a text feature to retrieve all text in the video frame. For example, the image processing module 206 converts the video frame containing “CLASH OF THE TITANS” into a gray scale image. Then the image processing module 206 determines the gray scale image containing four text features in the gray scale image, so the gray scale image is cut into four areas. The image processing module 206 analyzes the four areas with text features to retrieve four vocabularies “CLASH”, “OF”, “THE”, “TITANS”.

The web searching module 208 is operable to search information on the text on the Internet 30. For example, the web searching module 208 can search information on the text of “CLASH OF THE TITANS” in a relevant Internet search engine.

In one embodiment, the web searching module 208 of the set-top box 20 comprises a text selecting module 2080, a website selecting module 2082, and a text searching module 2084.

The text selecting module 2080 is operable to select object text from the one or more text in response to a second instruction input by the user. For example, the image processing module 206 analyzes the text “CLASH OF THE TITANS”. The user is interested in the text “TITANS”, then the user sends a text selecting instruction to the set-top box 20, and the set-top box 20 selects “TITANS” as object text by way of the text selecting module 2080.

The website selecting module 2082 is operable to select an object website from a plurality of websites in response to a third instruction input by the user. For example, the user sets several internet search websites, such as “baidu.com”, “google.com”, in the set-top box 20 in advance. The user can select “google.com” as the object website to search information by way of the website selecting module 2082.

The text searching module 2084 is operable to search information on the object text on the selected object website. For example, the text searching module 2084 searches information on the text of “TITANS” in the “google.com”.

In another embodiment, the set-top box 20 may comprises an output module 210 operable to transmit the information on the text to the television 10 for display. For example, the output module 210 transmits the information on the text of “TITANS” to the television 10, and accordingly the television 10 displays the information on the text of “TITANS”.

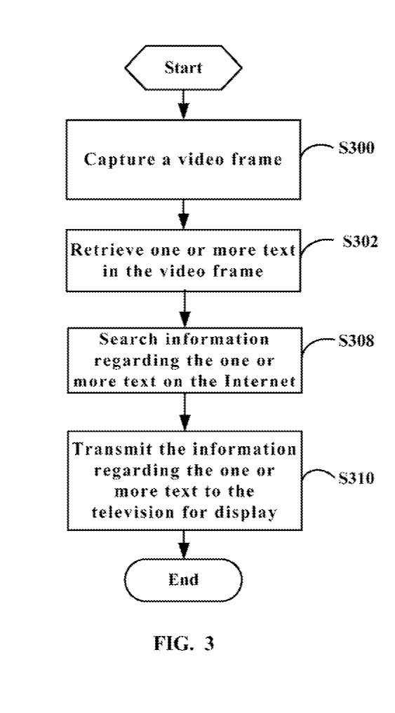

FIG. 3 is a flowchart of one embodiment of a method for searching text in accordance with the present disclosure. The method is executed by the functional modules of FIG. 2. Depending on the embodiment, additional blocks may be added, others deleted, and the ordering of blocks may be changed while remaining well within the scope of the disclosure.

In block 5300, the image capturing module 204 captures a video frame of a video program of the television 10 in response to a first instruction input by a user. For example, a user sends an image capturing instruction to the set-top box 20 by the remote controller 40 if the user is interested in the text in the television program. The text could include letters and numbers and can be part of the title of the television program, subtitle, or other text in the television program. The image capturing module 204 captures a current video frame from the TV 10 when receiving the image capturing instruction. For example, the TV 10 is playing premiere of “CLASH OF THE TITANS”. The user can send an image capturing instruction to the set-top box 20 by the remote controller 40 when the user is interested in “CLASH OF THE TITANS”. Then the image capturing module 204 captures a video frame containing the text “CLASH OF THE TITANS” from the TV 10.

In block 5302, the image processing module 206 analyzes the video frame to retrieve text, such as “CLASH OF THE TITANS” from the video frame. For example, the image processing module 206 converts the video frame containing “CLASH OF THE TITANS” into a gray scale image. Then the image processing module 206 determines the gray scale image containing four text features in the gray scale image, so the gray scale image is cut into four areas. The processing module 206 analyzes the four areas with text features to retrieve four vocabularies “CLASH”, “OF”, “THE” “TITANS”.

In block 5308, the web searching module 208 searches information on the text on the Internet 30. For example, the web searching module 208 can search information on “CLASH OF THE TITANS” in the google.com.

In block 5310, the output module 210 transmits the information on the text to the television 10 for display.

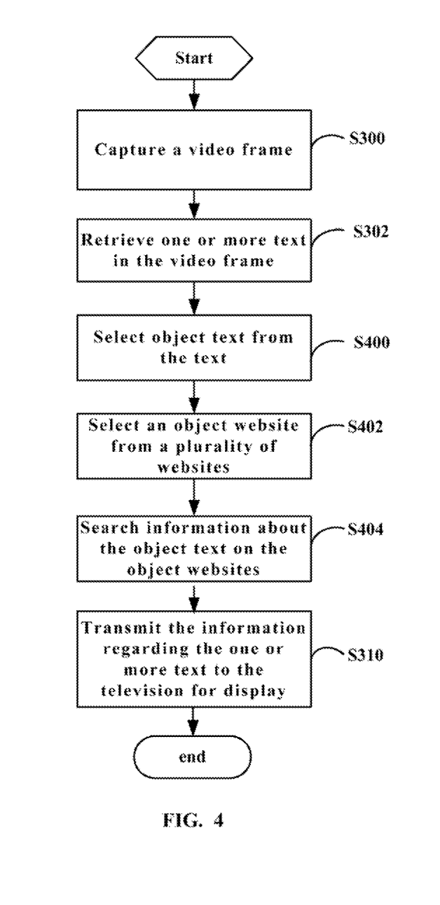

FIG. 4 is a flowchart of another embodiment of a method for searching text in accordance with the present disclosure. Blocks 5300, 5302, and 5310 in FIG. 4 are the same as blocks 5300, 5302, and 5310 in FIG. 3, so descriptions are omitted

In block 5400, the text selecting module 2080 selects object text from the one or more text in response to a second instruction input by the user. For example, the image processing module 206 analyzes the text “CLASH OF THE TITANS”. The user is interested in the text “TITANS”, then the user sends a text selecting instruction to the set-top box 20, and the set-top box 20 selects “TITANS” as object text by way of the text selecting module 2080.

In block 5402, the website selecting module 2082 selects an object website from a plurality of websites in response to a third instruction input by the user. For example, the user sets several websites, such as “baidu.com” and “google.com”, in the set-top box 20 in advance. The user can select “google.com” as the object website to search information by way of the website selecting module 2082.

In block S404, the text searching module 2084 searches information on the object text on the selected object website. For example, the text searching module 2084 searches information on “TITANS” in the “google.com”.

The set-top box 20 of the present disclosure can retrieve the text accompanying with the TV programs, and searches information on the text on the Internet 30. Thus, user experiences of watching TV is improved.

While various embodiments of the present disclosure have been described above, it should be understood that they have been presented using example and not using limitation. Thus the breadth and scope of the present disclosure should not be limited by the above-described embodiments, but should be defined in accordance with the following claims and their equivalents.

What is claimed is:

1. A set-top box, comprising:
at least one processor;
a storage system;
one or more programs that are stored in the storage system and are executed by the at least one processor, the one or more programs comprising:
an image capturing module operable to capture a video frame of a video program of a television in response to a first instruction input by a user;
an image processing module operable to retrieve one or more text in the video frame;
a web searching module operable to search information regarding the one or more text on the Internet; and
an output module operable to transmit the information regarding the one or more text to the television for display.

2. The set-top box of claim 1, wherein the web searching module comprises:
a text selecting module operable to select object text from the one or more text in response to a second instruction input by the user;
a website selecting module operable to select an object website from a plurality of websites in response to a third instruction input by the user; and
a text searching module operable to search information regarding the object text on the selected object website.

3. The set-top box of claim 1, wherein the image processing module converts the video frame into a gray scale image, and retrieves the text from the gray scale image.

4. A method for searching text, comprising:
capturing a video frame of a video program of a television in response to a first instruction input by a user;
retrieving one or more text in the video frame;
searching information regarding the one or more text on the Internet; and
transmitting the information regarding the one or more text to the television for display.

5. The method of claim 4, wherein the step of searching information regarding the text on the Internet comprises:
selecting object text from the one or more text in response to a second instruction input by the user;
selecting an object website from a plurality of websites in response to a third instruction input by the user; and
searching information on the object text on the selected object website.

6. The method of claim 4, wherein the step of analyzing the video frame to retrieve text in the video frame comprises:
converting the video frame into a gray scale image; and
retrieving the text from the gray scale image.
